(19) United States
(12) Patent Application Publication
(10) Pub. No.: US 2025/0136275 A1
(43) Pub. Date: May 1, 2025

(54) Tool for Loading a Payload on a Payload Retrieval Apparatus, Machine Including a Loading Tool, and Method of Use

(71) Applicant: Wing Aviation LLC, Palo Alto, CA (US)

(72) Inventor: André Peter Prager, Sunnyvale, CA (US)

(21) Appl. No.: 18/934,644

(22) Filed: Nov. 1, 2024

Related U.S. Application Data
(60) Provisional application No. 63/595,135, filed on Nov. 1, 2023.

(51) Int. Cl. B64D 1/08

(52) U.S. Cl. CPC B64D 1/08

(57) ABSTRACT

A tool for loading a payload on a payload retrieval apparatus includes a support body and a guide extending outward from the support body. The guide has an elongated configuration and a cross-sectional area that is narrower than the support body. The guide is configured to be inserted into a channel of the payload retrieval apparatus and to position the support body at an end of the channel adjacent to a payload holding structure. The tool also includes a hanger configured to hold the payload. The hanger is movable with respect to the support body between a closed position and a release position.

### CROSS REFERENCE TO RELATED APPLICATIONS

This application claims priority to U.S. Provisional Patent Application No. 63/595,135, filed Nov. 1, 2023, the contents of which are incorporated by reference.

### BACKGROUND

An uncrewed vehicle, which may also be referred to as an autonomous vehicle, is a vehicle capable of travel without a physically-present human operator. The term “unmanned” may sometimes be used instead of, or in addition to, “uncrewed,” and it should be understood that both terms have the same meaning, and may be used interchangeably. An uncrewed vehicle may operate in a remote-control mode, in an autonomous mode, or in a partially autonomous mode.

When an uncrewed vehicle operates in a remote-control mode, a pilot or driver that is at a remote location can control the uncrewed vehicle via commands that are sent to the uncrewed vehicle via a wireless link. When the uncrewed vehicle operates in autonomous mode, the uncrewed vehicle typically moves based on pre-programmed navigation waypoints, dynamic automation systems, or a combination of these. Further, some uncrewed vehicles can operate in both a remote-control mode and an autonomous mode, and in some instances may do so simultaneously. For instance, a remote pilot or driver may wish to leave navigation to an autonomous system while manually performing another task, such as operating a mechanical system for picking up objects, as an example.

Various types of uncrewed vehicles exist for various different environments. For instance, uncrewed vehicles exist for operation in the air, on the ground, underwater, and in space. Examples include quad-copters and tail-sitter UAVs, among others. Uncrewed vehicles also exist for hybrid operations in which multi-environment operation is possible. Examples of hybrid uncrewed vehicles include an amphibious craft that is capable of operation on land as well as on water or a floatplane that is capable of landing on water as well as on land. Other examples are also possible.

### SUMMARY

The present embodiments are directed to loading a payload onto a payload retrieval apparatus. Accurately placing the payload onto the payload retrieval apparatus allows for high rates of successful retrieval of the payload by a UAV.

In one aspect, a tool for loading a payload on a payload retrieval apparatus is provided. The tool includes a support body and a guide extending outward from the support body. The guide has an elongated configuration and a cross-sectional area that is narrower than the support body. The guide is configured to be inserted into a channel of the payload retrieval apparatus and to position the support body at an end of the channel adjacent to a payload holding structure. The tool also includes a hanger configured to hold the payload. The hanger is movable with respect to the support body between a closed position and a release position.

In another aspect, a machine for loading a payload onto a payload retrieval apparatus is provided. The machine includes a mobile base including a drive for moving the base over a surface. An adjustable arm is attached to the mobile base. A tool according to the disclosure is attached to the adjustable arm.

In another aspect, a method of loading a payload onto a payload retrieval apparatus is provided. The method includes securing a payload to a loading tool. The loading tool includes a support body, a guide extending outward from the support body, and a hanger that holds the payload. The guide has an elongated configuration and a cross-sectional area that is narrower than the support body. The method also includes inserting the guide of the loading tool into a channel of the payload retrieval apparatus so as to position the support body at an end of the channel adjacent to a payload holding structure of the payload retrieval apparatus. The method also includes moving the hanger of the loading tool with respect to the support body from a closed position to a release position to release the payload such that the payload is held by the payload holding structure of the payload retrieval apparatus.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1A is a simplified illustration of an uncrewed aerial vehicle, according to an example embodiment.

FIG. 1B is a simplified illustration of an uncrewed aerial vehicle, according to an example embodiment.

FIG. 1C is a simplified illustration of an uncrewed aerial vehicle, according to an example embodiment.

FIG. 1D is a simplified illustration of an uncrewed aerial vehicle, according to an example embodiment.

FIG. 1E is a simplified illustration of an uncrewed aerial vehicle, according to an example embodiment.

FIG. 2 is a simplified block diagram illustrating components of an uncrewed aerial vehicle, according to an example embodiment.

FIG. 3 is a simplified block diagram illustrating a UAV system, according to an example embodiment.

FIGS. 4A, 4B, and 4C show a payload delivery apparatus, according to example embodiments.

FIG. 5 shows a perspective view of a payload delivery apparatus according to an example embodiment.

FIG. 6 shows a perspective view of a payload coupling apparatus according to an example embodiment.

FIG. 7 shows a side view of a handle of a payload according to an example embodiment.

FIG. 8 shows a pair of locking pins engaging a handle of a payload according to an example embodiment.

FIG. 9 is a perspective view of payload retrieval apparatus according to an example embodiment.

FIG. 10 shows a sequence of steps A-D performed in the retrieval of a payload from the payload retrieval apparatus of FIG. 9.

FIG. 11A shows a perspective view of a loading tool according to an example embodiment.

FIG. 11B shows a side view of the loading tool of FIG. 11A.

FIG. 11C shows a front view of the loading tool of FIG. 11A.

FIGS. 12A-12C illustrate the use of a loading tool to load a payload onto a payload retrieval apparatus according to an example embodiment.

FIGS. 13A and 13B illustrate the operation of a hanger to release a payload from a loading tool according to an example embodiment.

FIGS. 14A and 14B illustrate the attachment of a payload to a loading tool according to an example embodiment.

FIG. 15 shows a side view of a loading machine according to an example embodiment.

FIG. 16 shows a perspective view of a portion of the loading machine of FIG. 15 in an extended position.

FIG. 17 shows a perspective view of a portion of the loading machine of FIG. 15 in a retracted position.

### DETAILED DESCRIPTION

Exemplary methods and systems are described herein. It should be understood that the word “exemplary” is used herein to mean “serving as an example, instance, or illustration.” Any implementation or feature described herein as “exemplary” or “illustrative” is not necessarily to be construed as preferred or advantageous over other implementations or features. In the figures, similar symbols typically identify similar components, unless context dictates otherwise. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

### I. Overview

The present embodiments are directed to the loading of a payload onto a payload retrieval apparatus that is configured to provide the payload to a UAV for delivery. The UAV includes a payload coupling apparatus at the end of a tether and is operable to retrieve the payload from the payload retrieval apparatus during flight. While hovering or moving over the payload retrieval apparatus, the UAV lowers the payload coupling apparatus on the tether. The payload retrieval apparatus holds the payload and guides the payload coupling apparatus to the payload where it is secured on the payload coupling apparatus. The UAV may then retract the tether and continue flight for delivery of the payload to a delivery site.

The payload retrieval apparatus includes a channel that receives the payload coupling apparatus and guides the payload coupling apparatus through the channel. A payload holding structure is disposed at the end of the channel and holds the payload until it is retrieved by the payload coupling apparatus. The loading tool of the disclosure helps consistently secure the payload on the payload holding structure in a manner that allows for reliable retrieval by the payload coupling apparatus.

The loading tool is configured to hold the payload until it is secured to the payload retrieval apparatus. In embodiments of the disclosure, the loading tool includes a guide that extends from a body of the tool and is configured to be inserted into the channel of the payload retrieval apparatus. As the guide moves into position within the channel, the body of the loading tool may be moved into a predetermined position at the end of the channel. The payload may be secured on a hanger of the loading tool. To release the payload, the hanger may be moved from a closed position to a release position in which the loading tool lets go of the payload. If the loading tool is in the proper position, the release of the payload results in the payload being secured on the payload holding structure of the payload retrieval apparatus.

In some embodiments, the loading tool is integrated into a machine for loading one or more payloads onto a payload retrieval apparatus. The machine includes a mobile base with a drive for moving the base over a surface and an adjustable arm attached to the mobile base. The loading tool of the disclosure is attached to the adjustable arm such that the adjustable arm can position the loading tool in a desired position on the payload retrieval apparatus. In some embodiments, the machine may include storage for holding one or more payloads so that the machine can be used to load the payloads onto more than one payload retrieval apparatus.

Further details and other embodiments of loading tools and loading machines according to the disclosure are described in more detail below.

### II. Illustrative Uncrewed Vehicles

Herein, the terms “uncrewed aerial vehicle” and “UAV” refer to any autonomous or semi-autonomous vehicle that is capable of performing some functions without a physically present human pilot.

A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “uncrewed aerial vehicle system” (UAVS), or “uncrewed aerial system” (UAS) may also be used to refer to a UAV.

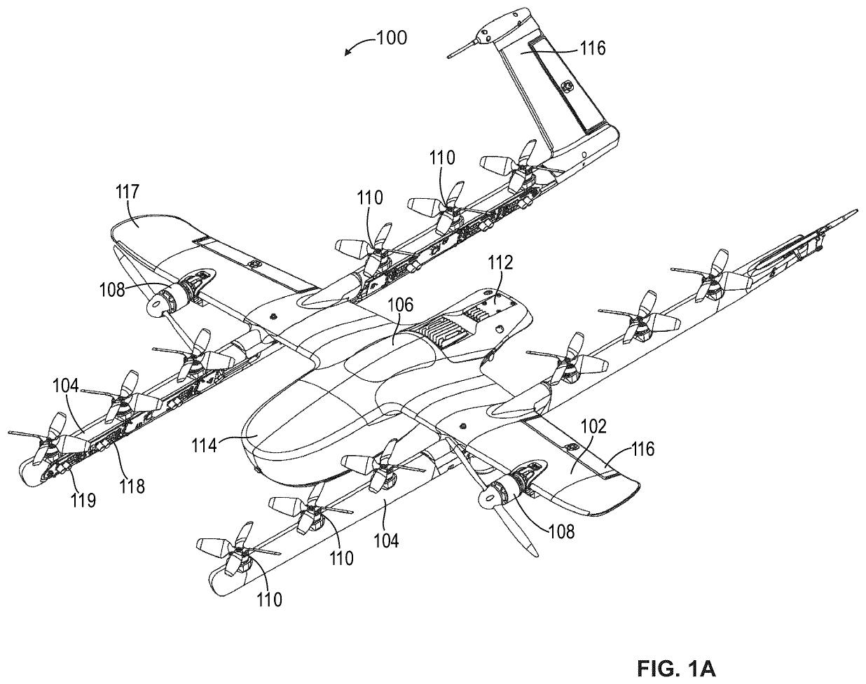

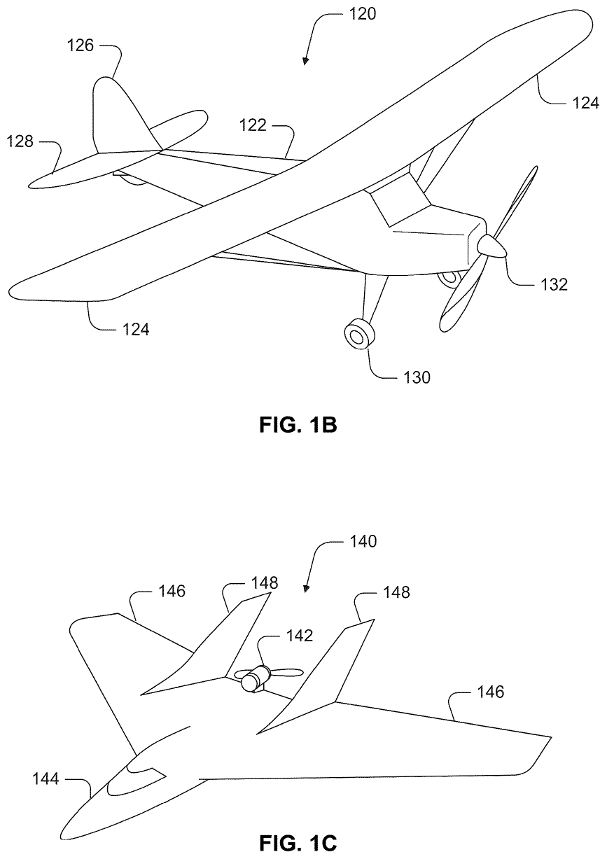

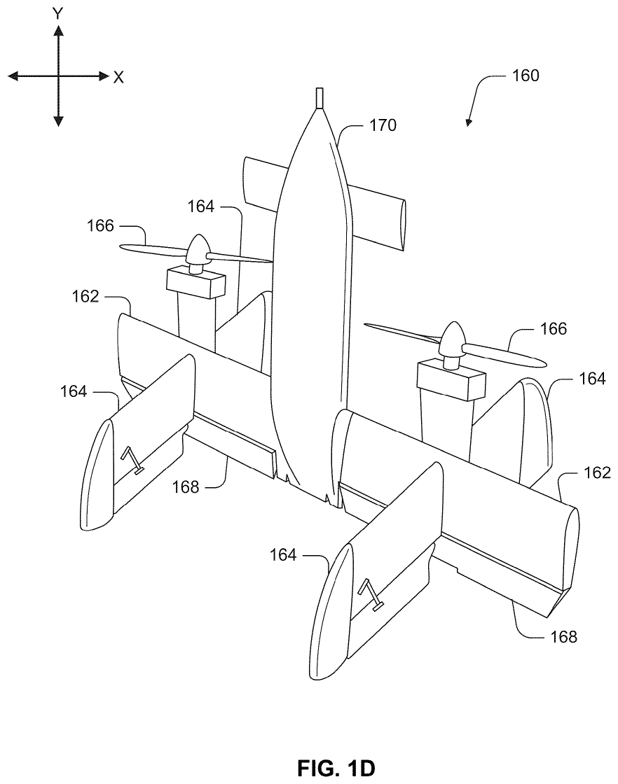

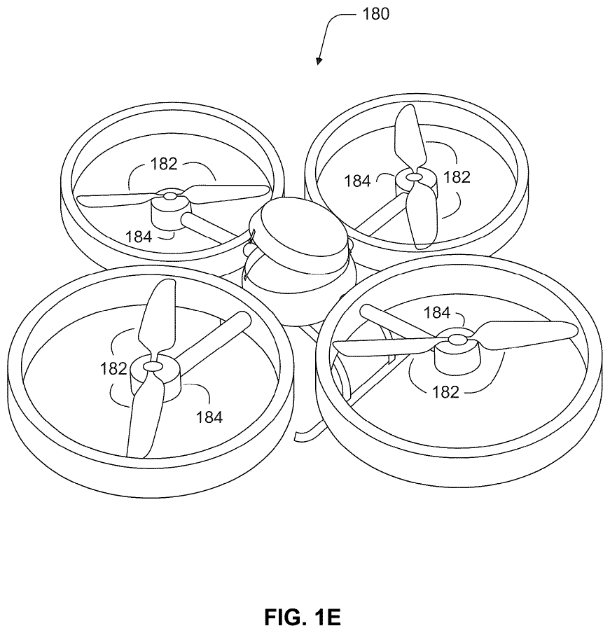

FIG. 1A is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may include elevators 115 and terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, UAVs with more wings (e.g., an “x-wing” configuration with four wings), are also possible. Although FIG. 1 illustrates two wings 102, two booms 104, two horizontal propulsion units 108, and six vertical propulsion units 110 per boom 104, it should be appreciated that other variants of UAV 100 may be implemented with more or fewer of these components. For example, UAV 100 may include four wings 102, four booms 104, and more or fewer propulsion units (horizontal or vertical).

Similarly, FIG. 1B shows another example of a fixed-wing UAV 120. The fixed-wing UAV 120 includes a fuselage 122, two wings 124 with an airfoil-shaped cross section to provide lift for the UAV 120, a vertical stabilizer 126 (or fin) to stabilize the plane's yaw (turn left or right), a horizontal stabilizer 128 (also referred to as an elevator or tailplane) to stabilize pitch (tilt up or down), landing gear 130, and a propulsion unit 132, which can include a motor, shaft, and propeller.

FIG. 1C shows an example of a UAV 140 with a propeller in a pusher configuration. The term “pusher” refers to the fact that a propulsion unit 142 is mounted at the back of the UAV and “pushes” the vehicle forward, in contrast to the propulsion unit being mounted at the front of the UAV. Similar to the description provided for FIGS. 1A and 1B, FIG. 1C depicts common structures used in a pusher plane, including a fuselage 144, two wings 146, vertical stabilizers 148, and the propulsion unit 142, which can include a motor, shaft, and propeller.

FIG. 1D shows an example of a tail-sitter UAV 160. In the illustrated example, the tail-sitter UAV 160 has fixed wings 162 to provide lift and allow the UAV 160 to glide horizontally (e.g., along the x-axis, in a position that is approximately perpendicular to the position shown in FIG. 1D). However, the fixed wings 162 also allow the tail-sitter UAV 160 to take off and land vertically on its own.

For example, at a launch site, the tail-sitter UAV 160 may be positioned vertically (as shown) with its fins 164 and/or wings 162 resting on the ground and stabilizing the UAV 160 in the vertical position. The tail-sitter UAV 160 may then take off by operating its propellers 166 to generate an upward thrust (e.g., a thrust that is generally along the y-axis). Once at a suitable altitude, the tail-sitter UAV 160 may use its flaps 168 to reorient itself in a horizontal position, such that its fuselage 170 is closer to being aligned with the x-axis than the y-axis. Positioned horizontally, the propellers 166 may provide forward thrust so that the tail-sitter UAV 160 can fly in a similar manner as a typical airplane.

Many variations on the illustrated fixed-wing UAVs are possible. For instance, fixed-wing UAVs may include more or fewer propellers, and/or may utilize a ducted fan or multiple ducted fans for propulsion. Further, UAVs with more wings (e.g., an “x-wing” configuration with four wings), with fewer wings, or even with no wings, are also possible.

As noted above, some embodiments may involve other types of UAVs, in addition to or in the alternative to fixed-wing UAVs. For instance, FIG. 1E shows an example of a rotorcraft that is commonly referred to as a multicopter 180. The multicopter 180 may also be referred to as a quadcopter, as it includes four rotors 182. It should be understood that example embodiments may involve a rotorcraft with more or fewer rotors than the multicopter 180. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to the multicopter 180 in greater detail, the four rotors 182 provide propulsion and maneuverability for the multicopter 180. More specifically, each rotor 182 includes blades that are attached to a motor 184. Configured as such, the rotors 182 may allow the multicopter 180 to take off and land vertically, to maneuver in any direction, and/or to hover. Further, the pitch of the blades may be adjusted as a group and/or differentially, and may allow the multicopter 180 to control its pitch, roll, yaw, and/or altitude.

It should be understood that references herein to an “uncrewed” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of uncrewed aerial vehicle.

### III. Illustrative UAV Components

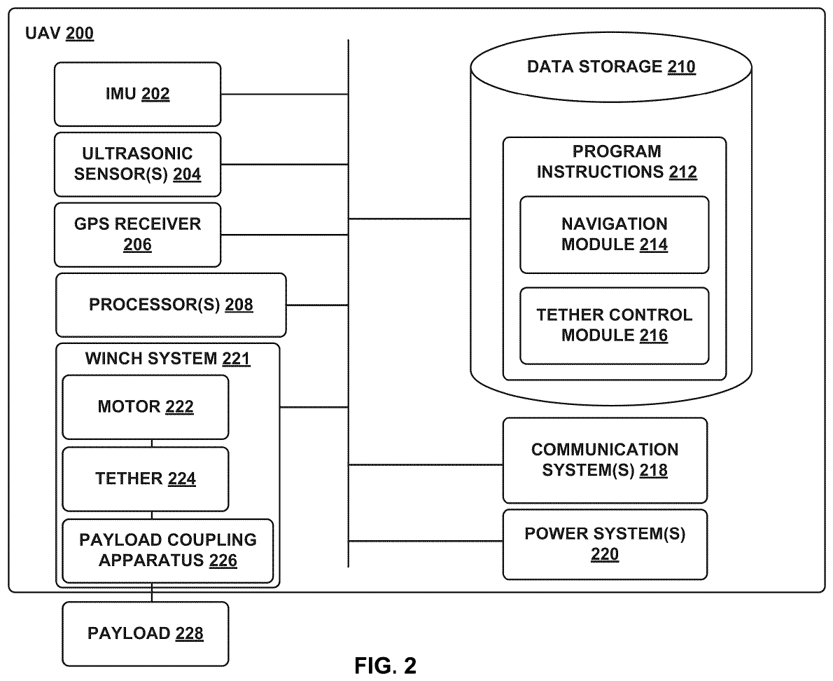

FIG. 2 is a simplified block diagram illustrating components of a UAV 200, according to an example embodiment. UAV 200 may take the form of, or be similar in form to, one of the UAVs 100, 120, 140, 160, and 180 described in reference to FIGS. 1A-1E. However, UAV 200 may also take other forms.

UAV 200 may include various types of sensors, and may include a computing system configured to provide the functionality described herein. In the illustrated embodiment, the sensors of UAV 200 include an inertial measurement unit (IMU) 202, ultrasonic sensor(s) 204, and a GPS 206, among other possible sensors and sensing systems.

In the illustrated embodiment, UAV 200 also includes one or more processors 208. A processor 208 may be a general-purpose processor or a special purpose processor (e.g., digital signal processors, application specific integrated circuits, etc.). The one or more processors 208 can be configured to execute computer-readable program instructions 212 that are stored in the data storage 210 and are executable to provide the functionality of a UAV described herein.

The data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of the one or more processors 208. In some embodiments, the data storage 210 can be implemented using a single physical device (e.g., one optical, magnetic, organic or other memory or disc storage unit), while in other embodiments, the data storage 210 can be implemented using two or more physical devices.

As noted, the data storage 210 can include computer-readable program instructions 212 and perhaps additional data, such as diagnostic data of the UAV 200. As such, the data storage 210 may include program instructions 212 to perform or facilitate some or all of the UAV functionality described herein. For instance, in the illustrated embodiment, program instructions 212 include a navigation module 214 and a tether control module 216.

### A. Sensors

In an illustrative embodiment, IMU 202 may include both an accelerometer and a gyroscope, which may be used together to determine an orientation of the UAV 200. In particular, the accelerometer can measure the orientation of the vehicle with respect to earth, while the gyroscope measures the rate of rotation around an axis. IMUs are commercially available in low-cost, low-power packages. For instance, an IMU 202 may take the form of or include a miniaturized MicroElectroMechanical System (MEMS) or a NanoElectroMechanical System (NEMS). Other types of IMUs may also be utilized.

An IMU 202 may include other sensors, in addition to accelerometers and gyroscopes, which may help to better determine position and/or help to increase autonomy of the UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of the UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmission of the wave and receiving the corresponding echo off an object. A typical application of an ultrasonic sensor for uncrewed vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with uncrewed vehicles. Such imaging sensor(s) have numerous possible applications, such as obstacle avoidance, localization techniques, ground tracking for more accurate navigation (e.g., by applying optical flow techniques to images), video feedback, and/or image recognition and processing, among other possibilities.

UAV 200 may also include a GPS receiver 206. The GPS receiver 206 may be configured to provide data that is typical of well-known GPS systems, such as the GPS coordinates of the UAV 200. Such GPS data may be utilized by the UAV 200 for various functions. As such, the UAV may use its GPS receiver 206 to help navigate to the caller's location, as indicated, at least in part, by the GPS coordinates provided by their mobile device. Other examples are also possible.

### B. Navigation and Location Determination

The navigation module 214 may provide functionality that allows the UAV 200 to, e.g., move about its environment and reach a desired location. To do so, the navigation module 214 may control the altitude and/or direction of flight by controlling the mechanical features of the UAV that affect flight (e.g., its rudder(s), elevator(s), aileron(s), and/or the speed of its propeller(s)).

In order to navigate the UAV 200 to a target location, the navigation module 214 may implement various navigation techniques, such as map-based navigation and localization-based navigation, for instance. With map-based navigation, the UAV 200 may be provided with a map of its environment, which may then be used to navigate to a particular location on the map. With localization-based navigation, the UAV 200 may be capable of navigating in an unknown environment using localization. Localization-based navigation may involve the UAV 200 building its own map of its environment and calculating its position within the map and/or the position of objects in the environment. For example, as a UAV 200 moves throughout its environment, the UAV 200 may continuously use localization to update its map of the environment. This continuous mapping process may be referred to as simultaneous localization and mapping (SLAM). Other navigation techniques may also be utilized.

In some embodiments, the navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, the navigation module 214 and/or other components and systems of the UAV 200 may be configured for “localization” to more precisely navigate to the scene of a target location. More specifically, it may be desirable in certain situations for a UAV to be within a threshold distance of the target location where a payload 228 is being delivered by a UAV (e.g., within a few feet of the target destination). To this end, a UAV may use a two-tiered approach in which it uses a more-general location-determination technique to navigate to a general area that is associated with the target location, and then use a more-refined location-determination technique to identify and/or navigate to the target location within the general area.

For example, the UAV 200 may navigate to the general area of a target destination where a payload 228 is being delivered using waypoints and/or map-based navigation. The UAV may then switch to a mode in which it utilizes a localization process to locate and travel to a more specific location. For instance, if the UAV 200 is to deliver a payload to a user's home, the UAV 200 may need to be substantially close to the target location in order to avoid delivery of the payload to undesired areas (e.g., onto a roof, into a pool, onto a neighbor's property, etc.). However, a GPS signal may only get the UAV 200 so far (e.g., within a block of the user's home). A more precise location-determination technique may then be used to find the specific target location.

Various types of location-determination techniques may be used to accomplish localization of the target delivery location once the UAV 200 has navigated to the general area of the target delivery location. For instance, the UAV 200 may be equipped with one or more sensory systems, such as, for example, ultrasonic sensors 204, infrared sensors (not shown), and/or other sensors, which may provide input that the navigation module 214 utilizes to navigate autonomously or semi-autonomously to the specific target location.

As another example, once the UAV 200 reaches the general area of the target delivery location (or of a moving subject such as a person or their mobile device), the UAV 200 may switch to a “fly-by-wire” mode where it is controlled, at least in part, by a remote operator, who can navigate the UAV 200 to the specific target location. To this end, sensory data from the UAV 200 may be sent to the remote operator to assist them in navigating the UAV 200 to the specific location.

As yet another example, the UAV 200 may include a module that is able to signal to a passer-by for assistance in either reaching the specific target delivery location; for example, the UAV 200 may display a visual message requesting such assistance in a graphic display, play an audio message or tone through speakers to indicate the need for such assistance, among other possibilities. Such a visual or audio message might indicate that assistance is needed in delivering the UAV 200 to a particular person or a particular location, and might provide information to assist the passer-by in delivering the UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once the UAV 200 arrives at the general area of a target delivery location, the UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, the UAV 200 may be configured to navigate by “sourcing” such directional signals—in other words, by determining where the signal is strongest and navigating accordingly. As another example, a mobile device can emit a frequency, either in the human range or outside the human range, and the UAV 200 can listen for that frequency and navigate accordingly. As a related example, if the UAV 200 is listening for spoken commands, then the UAV 200 could utilize spoken statements, such as “I′m over here!” to source the specific location of the person requesting delivery of a payload.

In an alternative arrangement, a navigation module may be implemented at a remote computing device, which communicates wirelessly with the UAV 200. The remote computing device may receive data indicating the operational state of the UAV 200, sensor data from the UAV 200 that allows it to assess the environmental conditions being experienced by the UAV 200, and/or location information for the UAV 200. Provided with such information, the remote computing device may determine latitudinal and/or directional adjustments that should be made by the UAV 200 and/or may determine how the UAV 200 should adjust its mechanical features (e.g., its rudder(s), elevator(s), aileron(s), and/or the speed of its propeller(s)) in order to effectuate such movements. The remote computing system may then communicate such adjustments to the UAV 200 so it can move in the determined manner.

### C. Communication Systems

In a further aspect, the UAV 200 includes one or more communication systems 218. The communications systems 218 may include one or more wireless interfaces and/or one or more wireline interfaces, which allow the UAV 200 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, a UAV 200 may include communication systems 218 that allow for both short-range communication and long-range communication. For example, the UAV 200 may be configured for short-range communications using Bluetooth and for long-range communications under a CDMA protocol. In such an embodiment, the UAV 200 may be configured to function as a “hot spot;” or in other words, as a gateway or proxy between a remote support device and one or more data networks, such as a cellular network and/or the Internet. Configured as such, the UAV 200 may facilitate data communications that the remote support device would otherwise be unable to perform by itself.

For example, the UAV 200 may provide a WiFi connection to a remote device, and serve as a proxy or gateway to a cellular service provider's data network, which the UAV might connect to under an LTE or a 3G protocol, for instance. The UAV 200 could also serve as a proxy or gateway to a high-altitude balloon network, a satellite network, or a combination of these networks, among others, which a remote device might not be able to otherwise access.

### D. Power Systems

In a further aspect, the UAV 200 may include power system(s) 220. The power system 220 may include one or more batteries for providing power to the UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

### E. Payload Delivery

The UAV 200 may employ various systems and configurations in order to transport and deliver a payload 228. In some implementations, the payload 228 of a given UAV 200 may include or take the form of a “package” designed to transport various goods to a target delivery location. For example, the UAV 200 can include a compartment, in which an item or items may be transported. Such a package may include one or more food items, purchased goods, medical items, or any other object(s) having a size and weight suitable to be transported between two locations by the UAV. In other embodiments, a payload 228 may simply be the one or more items that are being delivered (e.g., without any package housing the items).

In some embodiments, the payload 228 may be attached to the UAV and located substantially outside of the UAV during some or all of a flight by the UAV. For example, the package may be tethered or otherwise releasably attached below the UAV during flight to a target location. In some embodiments, the package may include various features that protect its contents from the environment, reduce aerodynamic drag on the system, and prevent the contents of the package from shifting during UAV flight. In other embodiments, the package may be a standard shipping package that is not specifically tailored for UAV flight.

In order to deliver the payload, the UAV may include a winch system 221 controlled by the tether control module 216 in order to lower the payload 228 to the ground while the UAV hovers above. As shown in FIG. 2, the winch system 221 may include a tether 224, and the tether 224 may be coupled to the payload 228 by a payload retriever 226. The tether 224 may be wound on a spool that is coupled to a motor 222 of the UAV. The motor 222 may take the form of a DC motor (e.g., a servo motor) that can be actively controlled by a speed controller. The tether control module 216 can control the speed controller to cause the motor 222 to rotate the spool, thereby unwinding or retracting the tether 224 and lowering or raising the payload retriever 226. In practice, the speed controller may output a desired operating rate (e.g., a desired RPM) for the spool, which may correspond to the speed at which the tether 224 and payload 228 should be lowered towards the ground. The motor 222 may then rotate the spool so that it maintains the desired operating rate.

In order to control the motor 222 via the speed controller, the tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as the motor 222 causes rotation of the spool, a rotary encoder may be used to measure this rotation. In doing so, the rotary encoder may be used to convert a rotary position to an analog or digital electronic signal used by the tether control module 216 to determine the amount of rotation of the spool from a fixed reference angle and/or to an analog or digital electronic signal that is representative of a new rotary position, among other options. Other examples are also possible.

Based on the data from the speed sensor, the tether control module 216 may determine a rotational speed of the motor 222 and/or the spool and responsively control the motor 222 (e.g., by increasing or decreasing an electrical current supplied to the motor 222) to cause the rotational speed of the motor 222 to match a desired speed. When adjusting the motor current, the magnitude of the current adjustment may be based on a proportional-integral-derivative (PID) calculation using the determined and desired speeds of the motor 222. For instance, the magnitude of the current adjustment may be based on a present difference, a past difference (based on accumulated error over time), and a future difference (based on current rates of change) between the determined and desired speeds of the spool.

In some embodiments, the tether control module 216 may vary the rate at which the tether 224 and payload 228 are lowered to the ground. For example, the speed controller may change the desired operating rate according to a variable deployment-rate profile and/or in response to other factors in order to change the rate at which the payload 228 descends toward the ground. To do so, the tether control module 216 may adjust an amount of braking or an amount of friction that is applied to the tether 224. For example, to vary the tether deployment rate, the UAV 200 may include friction pads that can apply a variable amount of pressure to the tether 224. As another example, the UAV 200 can include a motorized braking system that varies the rate at which the spool lets out the tether 224. Such a braking system may take the form of an electromechanical system in which the motor 222 operates to slow the rate at which the spool lets out the tether 224. Further, the motor 222 may vary the amount by which it adjusts the speed (e.g., the RPM) of the spool, and thus may vary the deployment rate of the tether 224. Other examples are also possible.

In some embodiments, the tether control module 216 may be configured to limit the motor current supplied to the motor 222 to a maximum value. With such a limit placed on the motor current, there may be situations where the motor 222 cannot operate at the desired operate specified by the speed controller. For instance, as discussed in more detail below, there may be situations where the speed controller specifies a desired operating rate at which the motor 222 should retract the tether 224 toward the UAV 200, but the motor current may be limited such that a large enough downward force on the tether 224 would counteract the retracting force of the motor 222 and cause the tether 224 to unwind instead. And as further discussed below, a limit on the motor current may be imposed and/or altered depending on an operational state of the UAV 200.

In some embodiments, the tether control module 216 may be configured to determine a status of the tether 224 and/or the payload 228 based on the amount of current supplied to the motor 222. For instance, if a downward force is applied to the tether 224 (e.g., if the payload 228 is attached to the tether 224 or if the tether 224 gets snagged on an object when retracting toward the UAV 200), the tether control module 216 may need to increase the motor current in order to cause the determined rotational speed of the motor 222 and/or spool to match the desired speed. Similarly, when the downward force is removed from the tether 224 (e.g., upon delivery of the payload 228 or removal of a tether snag), the tether control module 216 may need to decrease the motor current in order to cause the determined rotational speed of the motor 222 and/or spool to match the desired speed. As such, the tether control module 216 may be configured to monitor the current supplied to the motor 222. For instance, the tether control module 216 could determine the motor current based on sensor data received from a current sensor of the motor or a current sensor of the power system 220. In any case, based on the current supplied to the motor 222, determine if the payload 228 is attached to the tether 224, if someone or something is pulling on the tether 224, and/or if the payload retriever 226 is pressing against the UAV 200 after retracting the tether 224. Other examples are possible as well.

During delivery of the payload 228, the payload retriever 226 can be configured to secure the payload 228 while being lowered from the UAV by the tether 224, and can be further configured to release the payload 228 upon reaching ground level. The payload retriever 226 can then be retracted to the UAV by reeling in the tether 224 using the motor 222.

In some implementations, the payload 228 may be passively released once it is lowered to the ground. For example, a passive release mechanism may include one or more swing arms adapted to retract into and extend from a housing. An extended swing arm may form a hook on which the payload 228 may be attached. Upon lowering the release mechanism and the payload 228 to the ground via a tether, a gravitational force as well as a downward inertial force on the release mechanism may cause the payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of the payload 228 no longer forces the swing arm to extend from the housing. Retracting the swing arm into the housing may reduce the likelihood of the release mechanism snagging the payload 228 or other nearby objects when raising the release mechanism toward the UAV upon delivery of the payload 228.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, a UAV 200 could include an air-bag drop system or a parachute drop system. Alternatively, a UAV 200 carrying a payload could simply land on the ground at a delivery location. Other examples are also possible.

### IV. Illustrative UAV Deployment Systems

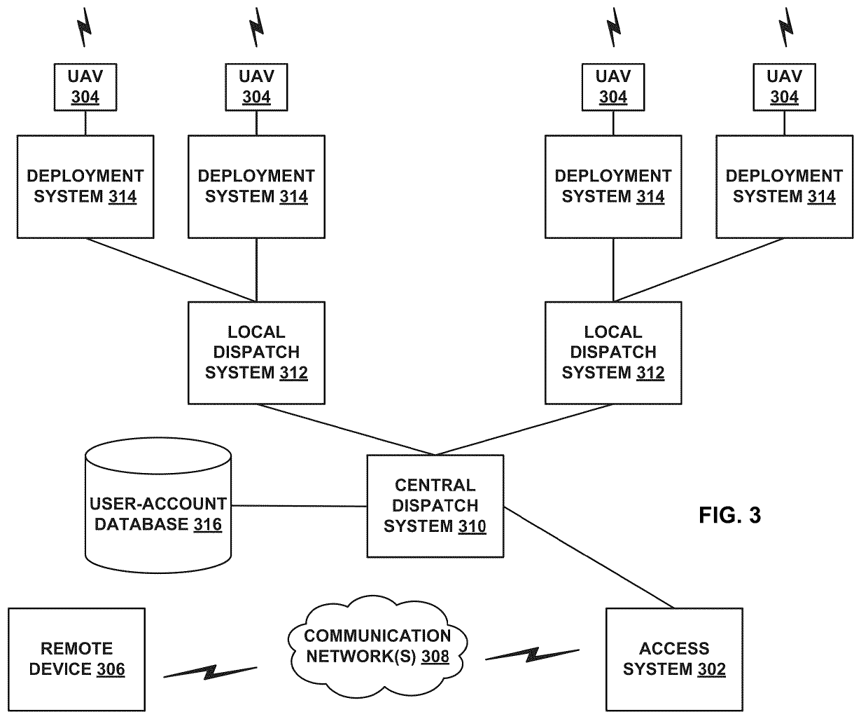

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3 is a simplified block diagram illustrating a distributed UAV system 300, according to an example embodiment.

In the illustrative UAV system 300, an access system 302 may allow for interaction with, control of, and/or utilization of a network of UAVs 304. In some embodiments, an access system 302 may be a computing system that allows for human-controlled dispatch of UAVs 304. As such, the control system may include or otherwise provide a user interface through which a user can access and/or control the UAVs 304.

In some embodiments, dispatch of the UAVs 304 may additionally or alternatively be accomplished via one or more automated processes. For instance, the access system 302 may dispatch one of the UAVs 304 to transport a payload to a target location, and the UAV may autonomously navigate to the target location by utilizing various on-board sensors, such as a GPS receiver and/or other various navigational sensors.

Further, the access system 302 may provide for remote operation of a UAV. For instance, the access system 302 may allow an operator to control the flight of a UAV via its user interface. As a specific example, an operator may use the access system 302 to dispatch a UAV 304 to a target location. The UAV 304 may then autonomously navigate to the general area of the target location. At this point, the operator may use the access system 302 to take control of the UAV 304 and navigate the UAV to the target location (e.g., to a particular person to whom a payload is being transported). Other examples of remote operation of a UAV are also possible.

In an illustrative embodiment, the UAVs 304 may take various forms. For example, each of the UAVs 304 may be a UAV such as those illustrated in FIGS. 1A-1E. However, UAV system 300 may also utilize other types of UAVs without departing from the scope of the invention. In some implementations, all of the UAVs 304 may be of the same or a similar configuration. However, in other implementations, the UAVs 304 may include a number of different types of UAVs. For instance, the UAVs 304 may include a number of types of UAVs, with each type of UAV being configured for a different type or types of payload delivery capabilities.

The UAV system 300 may further include a remote device 306, which may take various forms. Generally, the remote device 306 may be any device through which a direct or indirect request to dispatch a UAV can be made. (Note that an indirect request may involve any communication that may be responded to by dispatching a UAV, such as requesting a package delivery). In an example embodiment, the remote device 306 may be a mobile phone, tablet computer, laptop computer, personal computer, or any network-connected computing device. Further, in some instances, the remote device 306 may not be a computing device. As an example, a standard telephone, which allows for communication via plain old telephone service (POTS), may serve as the remote device 306. Other types of remote devices are also possible.

Further, the remote device 306 may be configured to communicate with access system 302 via one or more types of communication network(s) 308. For example, the remote device 306 may communicate with the access system 302 (or a human operator of the access system 302) by communicating over a POTS network, a cellular network, and/or a data network such as the Internet. Other types of networks may also be utilized.

In some embodiments, the remote device 306 may be configured to allow a user to request delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, the UAV system 300 may receive location information (e.g., GPS coordinates, etc.) from the user's mobile phone, or any other device on the user's person, such that a UAV can navigate to the user's location (as indicated by their mobile phone).

In an illustrative arrangement, the central dispatch system 310 may be a server or group of servers, which is configured to receive dispatch messages requests and/or dispatch instructions from the access system 302. Such dispatch messages may request or instruct the central dispatch system 310 to coordinate the deployment of UAVs to various target locations. The central dispatch system 310 may be further configured to route such requests or instructions to one or more local dispatch systems 312. To provide such functionality, the central dispatch system 310 may communicate with the access system 302 via a data network, such as the Internet or a private network that is established for communications between access systems and automated dispatch systems.

In the illustrated configuration, the central dispatch system 310 may be configured to coordinate the dispatch of UAVs 304 from a number of different local dispatch systems 312. As such, the central dispatch system 310 may keep track of which UAVs 304 are located at which local dispatch systems 312, which UAVs 304 are currently available for deployment, and/or which services or operations each of the UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when the central dispatch system 310 receives a request for UAV-related service (e.g., transport of an item) from the access system 302, the central dispatch system 310 may select a specific UAV 304 to dispatch. The central dispatch system 310 may accordingly instruct the local dispatch system 312 that is associated with the selected UAV to dispatch the selected UAV. The local dispatch system 312 may then operate its associated deployment system 314 to launch the selected UAV. In other cases, the central dispatch system 310 may forward a request for a UAV-related service to a local dispatch system 312 that is near the location where the support is requested and leave the selection of a particular UAV 304 to the local dispatch system 312.

In an example configuration, the local dispatch system 312 may be implemented as a computing system at the same location as the deployment system(s) 314 that it controls. For example, the local dispatch system 312 may be implemented by a computing system installed at a building, such as a warehouse, where the deployment system(s) 314 and UAV(s) 304 that are associated with the particular local dispatch system 312 are also located. In other embodiments, the local dispatch system 312 may be implemented at a location that is remote to its associated deployment system(s) 314 and UAV(s) 304.

Numerous variations on and alternatives to the illustrated configuration of the UAV system 300 are possible. For example, in some embodiments, a user of the remote device 306 could request delivery of a package directly from the central dispatch system 310. To do so, an application may be implemented on the remote device 306 that allows the user to provide information regarding a requested delivery, and generate and send a data message to request that the UAV system 300 provide the delivery. In such an embodiment, the central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to the central dispatch system 310, the local dispatch system(s) 312, the access system 302, and/or the deployment system(s) 314 may be combined in a single system, implemented in a more complex system, and/or redistributed among the central dispatch system 310, the local dispatch system(s) 312, the access system 302, and/or the deployment system(s) 314 in various ways.

Yet further, while each local dispatch system 312 is shown as having two associated deployment systems 314, a given local dispatch system 312 may alternatively have more or fewer associated deployment systems 314. Similarly, while the central dispatch system 310 is shown as being in communication with two local dispatch systems 312, the central dispatch system 310 may alternatively be in communication with more or fewer local dispatch systems 312.

In a further aspect, the deployment systems 314 may take various forms. In general, the deployment systems 314 may take the form of or include systems for physically launching one or more of the UAVs 304. Such launch systems may include features that provide for an automated UAV launch and/or features that allow for a human-assisted UAV launch. Further, the deployment systems 314 may each be configured to launch one particular UAV 304, or to launch multiple UAVs 304.

The deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, the deployment systems 314 and their corresponding UAVs 304 (and possibly associated local dispatch systems 312) may be strategically distributed throughout an area such as a city. For example, the deployment systems 314 may be strategically distributed such that each deployment system 314 is proximate to one or more payload pickup locations (e.g., near a restaurant, store, or warehouse). However, the deployment systems 314 (and possibly the local dispatch systems 312) may be distributed in other ways, depending upon the particular implementation. As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, the UAV system 300 may include or have access to a user-account database 316. The user-account database 316 may include data for a number of user accounts, and which are each associated with one or more persons. For a given user account, the user-account database 316 may include data related to or useful in providing UAV-related services. Typically, the user data associated with each user account is optionally provided by an associated user and/or is collected with the associated user's permission.

Further, in some embodiments, a person may be required to register for a user account with the UAV system 300, if they wish to be provided with UAV-related services by the UAVs 304 from UAV system 300. As such, the user-account database 316 may include authorization information for a given user account (e.g., a username and password), and/or other information that may be used to authorize access to a user account.

In some embodiments, a person may associate one or more of their devices with their user account, such that they can access the services of UAV system 300. For example, when a person uses an associated mobile phone, e.g., to place a call to an operator of the access system 302 or send a message requesting a UAV-related service to a dispatch system, the phone may be identified via a unique device identification number, and the call or message may then be attributed to the associated user account. Other examples are also possible.

### V. Illustrative Payload Delivery Systems

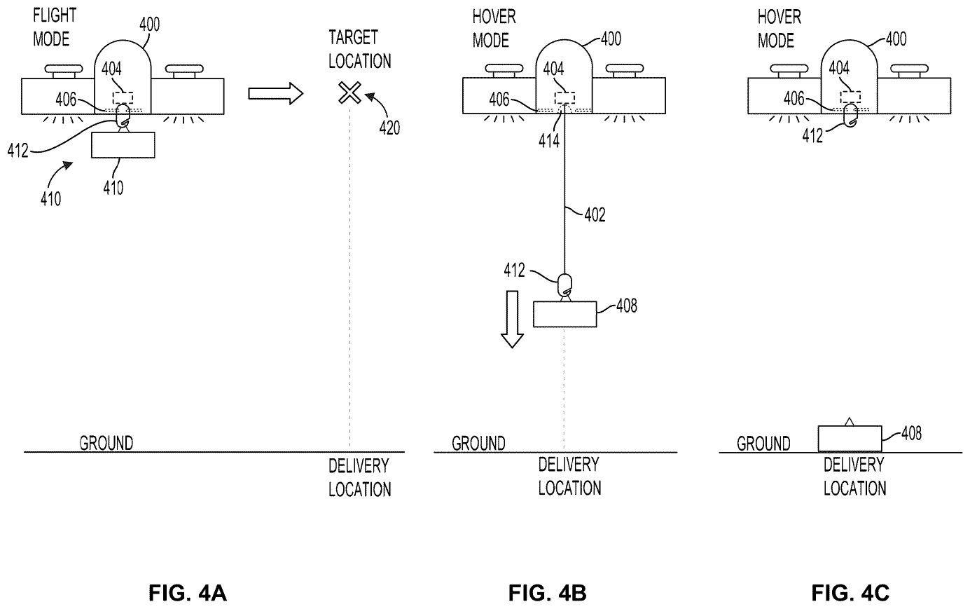

FIGS. 4A, 4B, and 4C show a UAV 400 that includes a payload delivery system 410 according to an example embodiment. As shown, payload delivery system 410 for UAV 400 includes a tether 402 coupled to a spool 404, a payload latch 406, and a payload 408 coupled to the tether 402 via a payload coupling apparatus 412. The payload latch 406 can function to alternately secure payload 408 and release the payload 408 upon delivery. For instance, as shown, the payload latch 406 may take the form of one or more pins that can engage a portion of the payload 408. Inserting the pins of the payload latch 406 into the payload coupling apparatus 412 may secure the payload coupling apparatus 412 within a receptacle 414 on the underside of the UAV 400, thereby preventing the payload 408 from being lowered from the UAV 400. In some embodiments, the payload latch 406 may be arranged to engage the spool 404 or the payload 408 rather than the payload coupling apparatus 412 in order to prevent the payload 408 from lowering. In other embodiments, the UAV 400 may not include the payload latch 406, and the payload delivery apparatus may be coupled directly to the UAV 400.

In some embodiments, the spool 404 can function to unwind the tether 402 such that the payload 408 can be lowered to the ground with the tether 402 and the payload coupling apparatus 412 from UAV 400. The payload 408 may itself be an item for delivery, and may be housed within (or otherwise incorporate) a parcel, container, or other structure that is configured to interface with the payload latch 406. In practice, the payload delivery system 410 of UAV 400 may function to autonomously lower payload 408 to the ground in a controlled manner to facilitate delivery of the payload 408 on the ground while the UAV 400 hovers above.

As shown in FIG. 4A, the payload latch 406 may be in a closed position (e.g., pins engaging the payload coupling apparatus 412) to hold the payload 408 against or close to the bottom of the UAV 400, or even partially or completely inside the UAV 400, during flight from a launch site to a target location 420. The target location 420 may be a point in space directly above a desired delivery location. Then, when the UAV 400 reaches the target location 420, the UAV's control system (e.g., the tether control module 216 of FIG. 2) may toggle the payload latch 406 to an open position (e.g., disengaging the pins from the payload coupling apparatus 412), thereby allowing the payload 408 to be lowered from the UAV 400. The control system may further operate the spool 404 (e.g., by controlling the motor 222 of FIG. 2) such that the payload 408, secured to the tether 402 by a payload coupling apparatus 412, is lowered to the ground, as shown in FIG. 4B.

Once the payload 408 reaches the ground, the control system may continue operating the spool 404 to lower the tether 402, causing over-run of the tether 402. During over-run of the tether 402, the payload coupling apparatus 412 may continue to lower as the payload 408 remains stationary on the ground. The downward momentum and/or gravitational forces on the payload coupling apparatus 412 may cause the payload 408 to detach from the payload coupling apparatus 412 (e.g., by sliding off a hook of the payload coupling apparatus 412). After releasing payload 408, the control system may operate the spool 404 to retract the tether 402 and the payload coupling apparatus 412 toward the UAV 400. Once the payload coupling apparatus reaches or nears the UAV 400, the control system may operate the spool 404 to pull the payload coupling apparatus 412 into the receptacle 414, and the control system may toggle the payload latch 406 to the closed position, as shown in FIG. 4C.

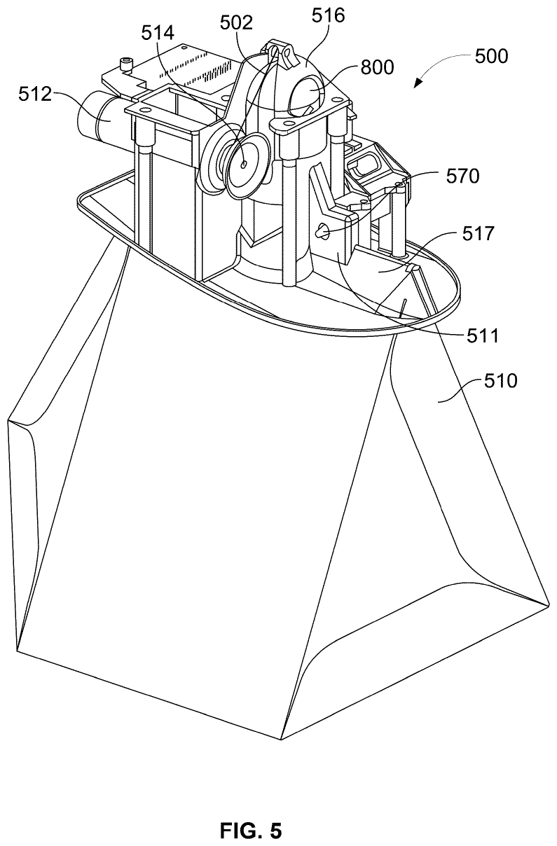

FIG. 5 shows a perspective view of a payload delivery apparatus 500 including payload 510, according to an example embodiment. The payload delivery apparatus 500 is positioned within a fuselage of a UAV and includes a winch 514 powered by motor 512, and a tether 502 spooled onto winch 514. The tether 502 is attached to a payload coupling apparatus or payload retriever positioned within a payload coupling apparatus receptacle 516. A payload 510 is secured to the payload coupling apparatus 800. In this embodiment a top portion 517 of payload 510 is secured within the fuselage of the UAV. A locking pin 570 is shown extending through handle 511 attached to payload 510 to positively secure the payload beneath the UAV during high speed flight.

FIG. 5 shows a payload 510 taking the shape of an aerodynamic hexagonally-shaped tote, where the base and side walls are six-sided hexagons and the tote includes generally pointed front and rear surfaces formed at the intersections of the side walls and base of the tote providing an aerodynamic shape. In other embodiments, the payload may have other shapes or forms.

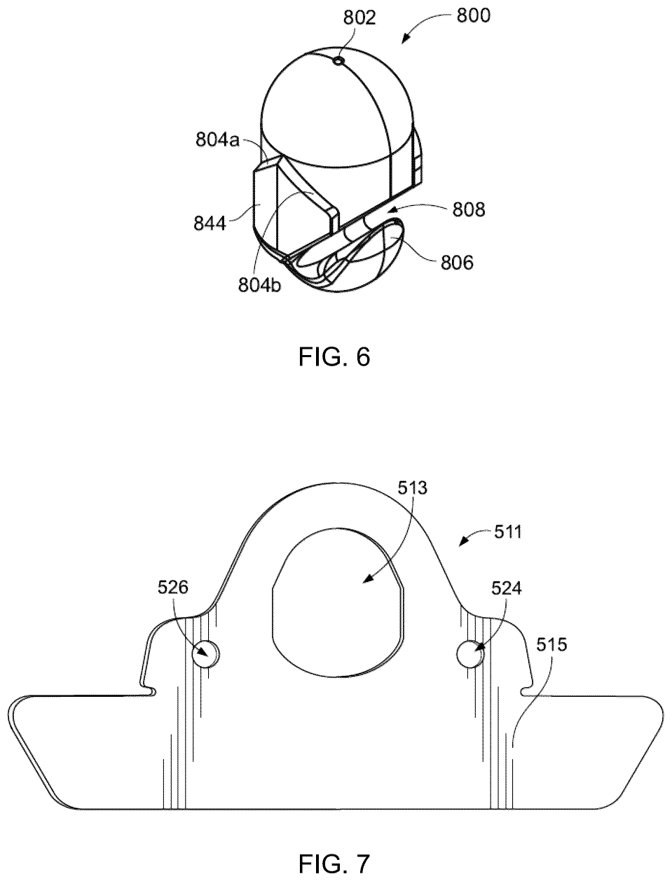

FIG. 6 is a perspective view of payload coupling apparatus 800 according to an example embodiment. Payload coupling apparatus 800 includes a tether mounting point 802 at the top of the payload coupling apparatus and a slot 808 adapted to receive a handle of a payload. Lower lip, or hook, 806 is formed beneath slot 808. Payload coupling apparatus 800 also includes outer protrusions 804 having helical cam surfaces 804a and 804b that are adapted to mate with corresponding cam mating surfaces to orient the payload coupling apparatus 800. Corresponding mating surfaces may be included within a receptacle in the fuselage of a UAV, or in a payload retrieval structure, as described in more detail below.

FIG. 7 is a side view of a handle 511 of a payload 510 configured to be carried by a UAV. The handle 511 includes an aperture 513 through which the hook of a payload coupling apparatus extends to suspend the payload during delivery or retrieval. The handle 511 includes a lower portion 515 that is secured to the top portion of a payload. Also included are holes 524 and 526 through which locking pins positioned within the fuselage of a UAV, may extend to secure the handle and payload in a secure position during high speed forward flight to a delivery location. In addition, holes 524 and 526 are also designed to receive pins of a payload holder for holding the payload in position on a payload retrieval apparatus. The handle may be comprised of a thin, flexible plastic material that provides sufficient strength to suspend the payload beneath a UAV during flight to a delivery site, and during delivery and/or retrieval of a payload. In practice, the handle may be bent to position the handle within a slot of a payload coupling apparatus.

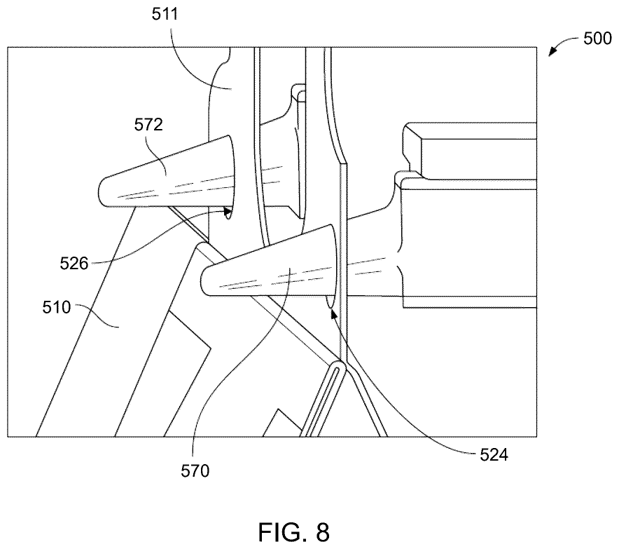

FIG. 8 shows a pair of pins 570, 572 extending through holes 524 and 526 in handle 511 of payload 510 to secure the handle 511 and top portion of payload 510 within the fuselage of a UAV. In this manner, the handle 511 and payload 510 may be secured within the fuselage of a UAV, or to a payload holder of a payload retrieval apparatus. In the illustrated embodiment, the pins 570 and 572 have a conical shape, which may help guide entry into the holes 524, 546. In other embodiments, the pins may have another shape, such as cylindrical. In some embodiments the pins 570 and 572 may completely plug the holes 524 and 526 of the handle 511 of payload 510, to provide a secure attachment of the handle and top portion of the payload within the fuselage of the UAV, or to secure the payload to a payload retrieval apparatus.

### VI. Illustrative Payload Retrieval Systems

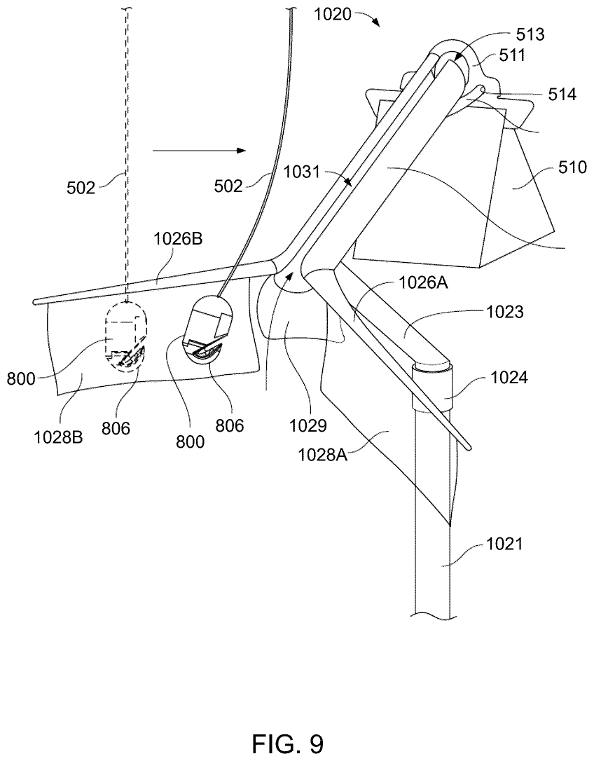

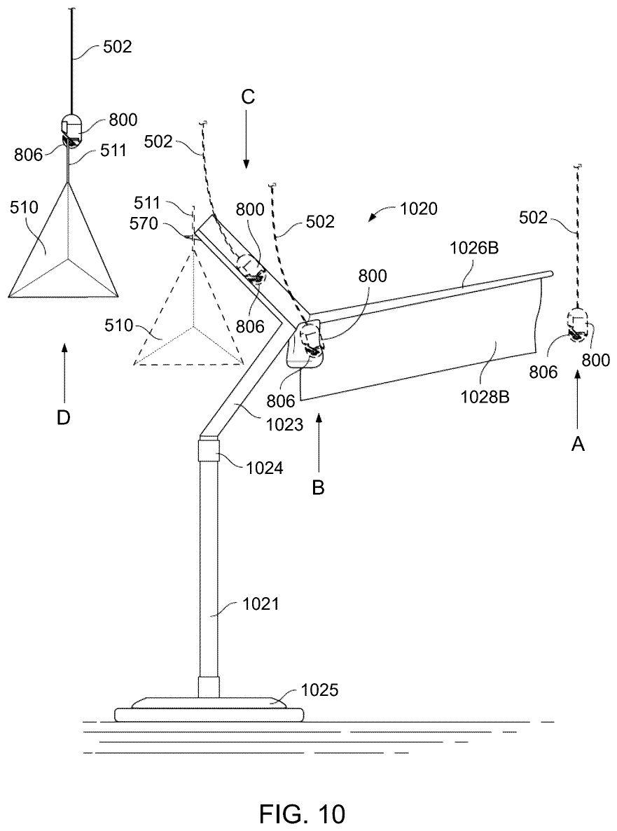

FIG. 9 is a perspective view of payload retrieval apparatus 1020 having a payload 510 positioned thereon, according to an example embodiment. The payload retrieval apparatus 1020 may be a permanent or non-permanent structure placed at a payload retrieval site. The apparatus includes a support 1021 that may be secured to a base or stand 1025 at its lower end (FIG. 10). Alternatively, the support 1021 may have a lower end that may be positioned within a corresponding hole in the ground or hole in an apparatus positioned on the ground. The payload retrieval apparatus 1020 may be readily folded up, like an umbrella stand, to provide for ease of transport. In addition, because of its non-permanent configuration, payload retrieval apparatus 1020 may not require any type permitting, which may not be the case for a permanent device used for UAV loading and unloading.

An angled extender 1023 may be attached at an upper end of the extending member 1021, and adapter 1024 may be used to adjust the height or angle of the angled extender 1023, and may have a threaded set screw with a knob to set the angled extender 1023 into a desired position. The angled extender 1023 is shown with an upper end secured to a tubular structure that forms a channel 1030. A first end of the channel may have a first extension or tether engager 1026A that extends in a first direction from a lower end of the channel 1030 and a second extension or tether engager 1026B that extends in a second direction from the lower end of the channel 1030. A second end of the channel 1030 may have a payload holder 570, 572 positioned near or thereon that is adapted to secure a payload 510 to the second end of the channel 1030.

A first shield 1028A is shown extending from the first tether engager 1026A, and another shield 1028B is shown extending from the second tether engager 1026B. The shields 1028A and 1028B may be made of a fabric material, or other material such as rubber or plastic. A central shield 1029 is also shown extending from the first end of channel 1030. The shields 1028A, 1028B, and 1029 serve to prevent a payload retriever 800 disposed on an end of a tether 502 from wrapping around the tether engagers 1026A, 1026B or other components of payload retrieval apparatus 1020 when the payload retriever comes into contact with tether engagers 1026A, 1026B during a payload retrieval operation.

Channel 1030 includes a tether slot 1031 extending from a first end to a second end of the channel 1030, and the tether slot 1031 allows for a payload retriever to be positioned within the channel 1030 attached to a tether which enters into the interior 1033 of the channel 1030 and extends through the tether slot 1031. A payload holder is shown that is a pair of pins 570, 572 that extend through openings in handle 511 of payload 510 to suspend payload 510 in position adjacent the second end of the channel 1030 ready to be retrieved by a payload retriever attached to a tether suspended from a UAV.

To provide for automatic retrieval of payload 510 with a payload retriever suspended from a UAV with a tether, payload 510 is secured to the payload holder 570, 572 on the second end of the channel 1030 at the payload retrieval site. A UAV arrives at the payload retrieval site with a tether 502 extending downwardly from the UAV and with the payload retriever 800 positioned on the end of the tether, as shown in FIGS. 9 and 10. The UAV approaches the payload retrieval apparatus 1020, and as it nears the payload retrieval apparatus 1020, the tether 502 comes into contact with the first or second tether engagers 1026A, 1026B. As the UAV moves forward, or the UAV is moved upwardly, or the payload retriever is winched upwardly to the UAV while the UAV is hovering in place (or any combination thereof), the tether slides inwardly along the first or second tether engager 1026A, 1026B where it is directed towards the first end of the channel 1030. With further forward or upward movement of the UAV, or upward winching of the payload retriever, the tether 502 moves through the tether slot 1031 of channel 1030 and eventually the payload retriever 800 attached to the tether 502 is pulled into the channel 1030 by the tether. The payload retriever 800 is pulled through the channel 1030 where it engages, and secures, the payload 510 secured to the payload holder 570, 572. The payload retriever 800 then pulls the payload 510 free from the payload holder 570, 572. Once the payload 510 is free from the payload holder 570, 572, the payload 510 may be winched upwardly into secure engagement with the UAV, and the UAV may continue on to a delivery site where the payload 510 may be delivered by the UAV.

FIG. 10 shows a sequence of steps A-D performed in the retrieval of payload 510 from payload retrieval apparatus 1020, shown in FIG. 9. A payload retriever, shown in FIG. 10 as payload coupling apparatus 800 having a hook or lip 806 positioned beneath slot 808, is attached to an end of tether 502 which is in turn attached to a UAV. At point A in the sequence of steps shown from right to left, payload retriever 800 is shown suspended at the end of tether 502 at a position below the height of tether engagers 1026A and 1026B. Payload retriever 800 and tether 502 move towards the payload retrieval apparatus 1020, where tether 502 contacts tether engager 1026A or tether engager 1026B, and tether 502 and payload retriever 800 move towards channel 1030 until payload retriever 800 is positioned just outside of channel 1030 shown at point B in the sequence. With further forward or upward movement of the UAV, or upward winching of payload retriever 800 (or any combination thereof), tether 502 extends through tether slot 1031 of channel 1030 and payload retriever 800 is positioned within channel 1030 as shown at point C of the sequence. With further forward or upward movement of the UAV, or upward winching of the payload retriever 800 (or any combination thereof), payload retriever 800 exits channel 1030 and hook or lip 806 of payload retriever 800 engages handle 511 of payload 510 and removes payload 510 from payload holder 570, 572 positioned on the end of the channel 1030. After removal of payload 510 from payload holder 570, 572 of payload retrieval apparatus 1020, at point D of the sequence, payload 510 is suspended from tether 502 with handle 511 of payload 510 positioned in slot 808 above hook or lip 806 of payload retriever 800, where payload 510 may be winched up to the UAV and flown for subsequent delivery at a payload delivery site.

### VII. Example Payload Loading Tools and Machines

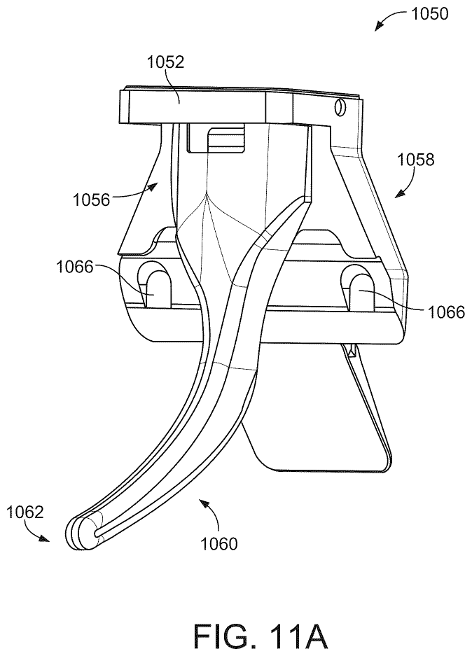

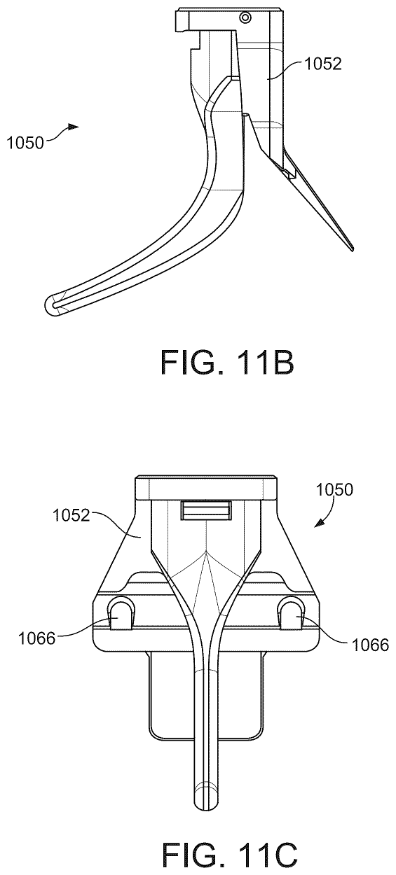

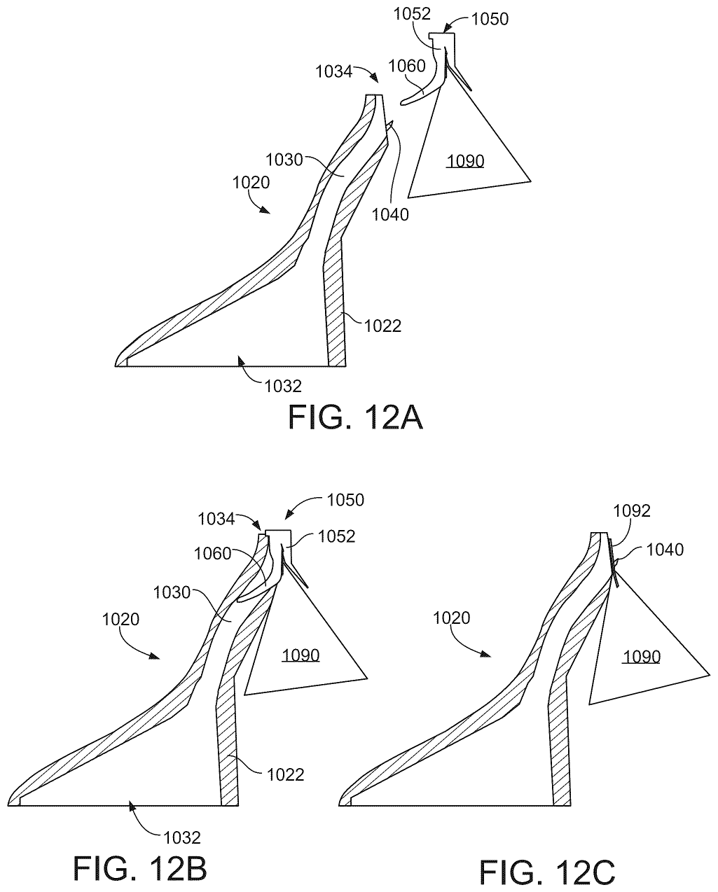

Embodiments of the present disclosure provide a tool for positioning a payload on a payload retrieval apparatus, such as payload retrieval apparatus 1020 described above. FIGS. 11A-11C show an embodiment of such a loading tool 1050. As illustrated in FIGS. 12A and 12B, the loading tool 1050 is operable to hold a payload 1090 and interact with the payload retrieval apparatus 1020 in order to position the payload 1090 in a desired location on the payload retrieval apparatus 1020 and place the payload 1090 on a payload holding structure of the payload retrieval apparatus 1020. Accordingly, when a payload coupling apparatus of a UAV is drawn through the payload retrieval apparatus 1020, the payload 1090 will be accurately positioned to be received by the payload coupling apparatus, in a manner similar to that illustrated in FIG. 10 above. For clarity, only a portion of the payload retrieval apparatus 1020 that includes a channel for receiving a payload coupling apparatus is shown in FIGS. 12A-12C.

As shown in FIGS. 11A-11C, the loading tool 1050 includes a support body 1052 that provides the main structural component of the loading tool 1050. As explained in more detail below, the support body 1052 may include mounting structures for holding the loading tool 1050 by another component, such as a loading machine. Alternatively, if the loading tool 1050 is operated by hand, the support body 1052 may provide a convenient area for holding the loading tool 1050. Furthermore, the support body 1052 may connect the other components of the loading tool 1050 and hold the components together.

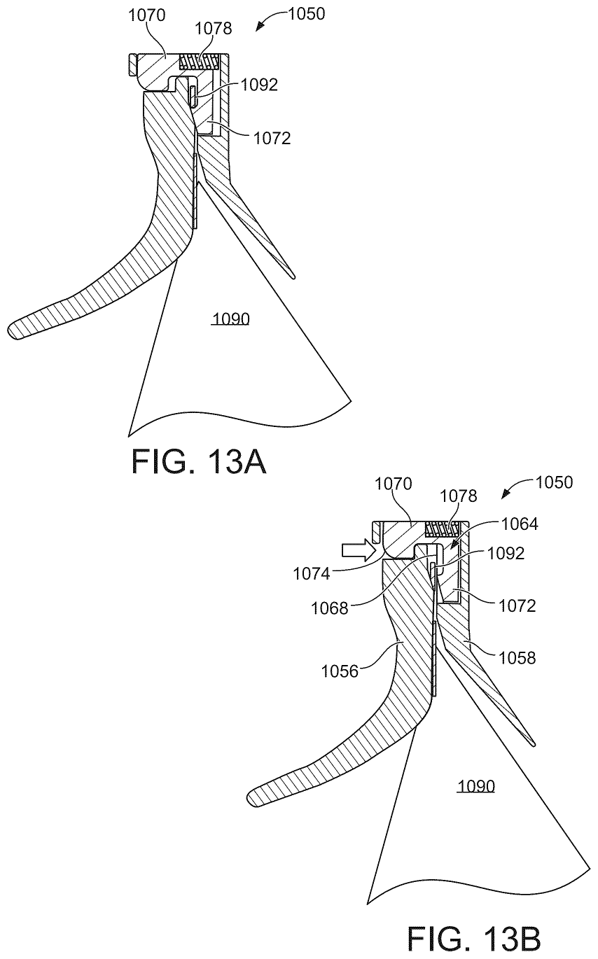

The loading tool 1050 also includes a guide 1060 that extends outward from the support body 1052 and is configured for guiding the loading tool 1050 into a desired position on the payload retrieval apparatus. Further, the loading tool 1050 also includes a hanger that is configured to hold a payload and release the payload when the loading tool 1050 is in the appropriate position on the payload retrieval apparatus. The hanger of the illustrated embodiment is substantially disposed inside the support body 1502, and is described in more detail below with respect to the cross-sectional views of FIGS. 13A and 13B.

As shown in FIGS. 11A-11C, in the illustrated embodiment, in order to appropriately interact with the configuration of the payload retrieval apparatus 1020, the guide 1060 extends both forward and downward from the support body 1052. In other embodiments, depending on the shape of the channel of the payload retrieval apparatus being used, the guide may extend more prominently forward or downward from the support body.

FIGS. 12A and 12B illustrate the positioning of the loading tool 1050 onto a payload retrieval apparatus 1020. The payload retrieval apparatus includes a frame 1022 that forms a channel 1030. The channel 1030 extends from a lower inlet end 1032 that has the shape of a funnel to a raised exit end 1034. A payload holding structure 1040 is positioned at the exit end 1034 of the channel 1030 and is configured to hold a payload for retrieval by a UAV. Accordingly, when a payload coupling apparatus is pulled through the channel 1030, it can retrieve the payload as it passes through the exit end 1034 of the channel 1030.

As shown in FIG. 12A, as the loading tool 1050 is moved toward the payload retrieval apparatus 1020, the guide 1060 is directed toward the exit end 1032 of the channel 1030. As the loading tool 1050 is further moved into position on the payload retrieval apparatus 1020, the guide 1060 is inserted into the channel 1030. As illustrated by FIG. 12B, further movement of the loading tool 1050 toward payload retrieval apparatus 1020 is restricted by the insertion of the guide 1060 into the channel 1030. Eventually, the guide 1060 is fully inserted into the channel and the support body 1052 of the loading tool 1050 comes to rest against the frame 1022 of the payload retrieval apparatus 1020.

As shown in FIG. 11A, the guide 1060 has an elongated configuration that extends to a narrow distal end 1062. This allows the guide 1060 to be easily inserted into the channel 1030 of the payload retrieval apparatus 1020. Further, the cross-sectional area of the guide 1060 is narrower than support body 1052, such that the guide 1060 may easily move into the channel 1030 while the support body 1052 is prevented from being inserted into the channel 1030 and comes to rest at the exit end 1034 of the channel 1030.

As explained further below, the positioning of the loading tool 1050 on the payload retrieval apparatus 1020 causes the payload 1090 to be released by the loading tool 1050. As a result, the handle 1092 of the payload 1090 drops onto the payload holding structure 1040, as shown in FIG. 12C. In the illustrated embodiment, the payload holding structure 1040 is configured as a pair of hooks that engage with apertures in the handle 1092, in a manner similar to the pins shown in FIG. 8.

FIGS. 13A and 13B illustrate the operation of a hanger 1070 that holds and release the payload 1090. As shown in FIG. 13A, the support body 1052 of the loading tool 1050 includes a slot 1054 that receives the handle 1092 of the payload 1090. The slot 1054 is positioned between a front portion 1056 and a rear portion 1058 of the support body 1052. The handle 1092 of the payload 1090 fits into the slot 1054 and is held in place by the hanger 1070, when the hanger 1070 is in a closed position, as shown in FIG. 13A. When the hanger 1070 moves to a release position, as shown in FIG. 13B, the handle 1092 is released and the payload 1090 is able to be freely placed on the holding structure 1040 of the payload retrieval apparatus 1020.

In the illustrated embodiment, the hanger 1070 includes a hook 1072 that holds an upper portion of the handle 1092 and prevents the payload 1090 from falling. In other embodiments, the hanger may have another configuration that is able to move between a holding position and a release position, in order to selectively retain or release the payload. For example, in some embodiments, the hanger includes a clamp that is configured to clamp opposing sides of the payload or the payload handle and hold the payload in place. Other releasable attachments for holding the payload are also possible.

In some embodiments, as shown in FIG. 13A, when the hanger 1070 is in the closed position, the hook 1072 extends across the slot 1054. As a result, the handle 1092 of the payload 1090 is prevented from being removed from the slot 1054 and is retained by the loading tool 1050. Further, this allows the hook 1072 to securely hold the payload handle 1072 with only a horizontal configuration and without the need for a raised end on the hook. Accordingly, removal of the payload handle 1092 from the hook 1072 may be carried out with a simple lateral motion of the hanger 1070. Alternatively, in other embodiments, the hook does not fully extend across the slot. For example, in some embodiments the hook securely retains the payload by including a raised end or a latch.

In some embodiments, the hook is configured to move into a receptacle in the rear portion of the support body when the hanger moves from the closed position to the release position such that a front surface of the rear portion of the support body slides the handle of the payload off the hook. For example, as shown in FIG. 13B, the rear portion 1058 of the support body 1052 of the loading tool 1050 includes a receptacle 1064 that is sized and shaped to receive the hook 1072 of the hanger 1070 when the hanger moves into the release position. When the hook 1072 moves into the receptacle 1064, it disengages from the payload handle 1092, thereby allowing the payload 1090 to be released onto the holding structure 1040 of the payload retrieval apparatus 1020. The payload handle 1092 is restricted from moving into the receptacle 1064 by a front surface 1068 of the rear portion 1058 of the support body 1052. As a result, when the hook 1072 recedes into the receptacle 1064, the handle 1092 is slid off the hook 1072.

In some embodiments, the loading tool includes a switch that is configured to move the hanger from the closed position to the release position. For example, in some embodiments the hanger includes a contact surface that is configured to push the hanger into the release position when the loading tool is moved into position on the payload coupling apparatus. In other embodiments, the switch may be independently activated by a loading machine or user.

As shown in FIG. 13B, the loading tool 1050 of the illustrated embodiment includes a switch in the form of a contact surface 1074 at the front of the hanger 1070. When the loading tool 1050 is positioned on the payload retrieval apparatus 1020 (as shown in FIG. 12B), a portion of the payload retrieval apparatus 1020 pushes the contact surface 1074 of the hanger 1070 as illustrated by the arrow in FIG. 13B. By pushing on the contact surface 1074, the hanger 1070 is moved to the release position so that the payload 1090 is released from the loading tool 1050.

In some embodiments, the hanger is biased toward the closed position. This helps prevent inadvertent release of the payload before the loading tool is positioned on the payload retrieval apparatus. For example, in the illustrated embodiment, the loading tool 1050 includes a spring 1078 that urges the hanger 1070 toward the closed position. The spring may be formed by a separate component, as in the illustrated embodiment, or may be formed by a flexible portion of the hanger or the support body. Using a separate spring may simplify manufacturing of the components of the loading tool, while forming the spring integrally with one of the other components of the loading tool may reduce costs and part counts. Various different spring configurations may be used to bias the hanger toward the closed position, such as coil springs, leaf springs, disc springs, extension springs, or other spring designs. Further, the hanger may be biased toward the closed position using another configuration, such as using a separate weight, or the weight of the hanger itself, to push the hanger into the closed position. For example, a portion of the hanger may sit on an inclined surface such that moving the hanger into the release position requires ‘lifting’ the hanger.

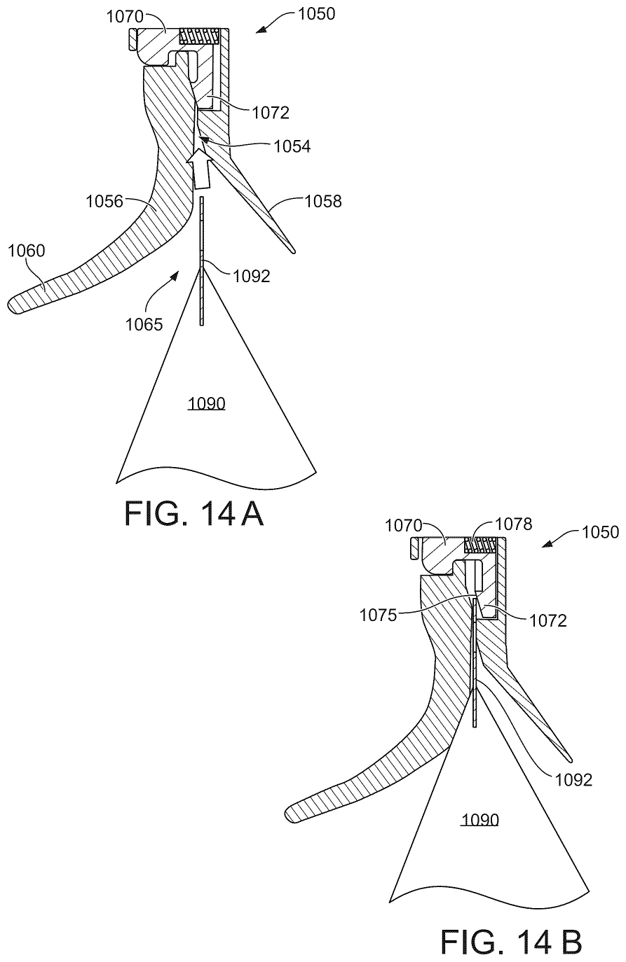

FIGS. 14A and 14B illustrate an example of the payload 1090 being secured to the loading tool 1050. As shown, in some embodiments, the loading tool includes a funnel to direct the payload for attachment to the loading tool. For example, loading tool 1050 includes a funnel 1065 that is formed between the front portion 1056 and the rear portion 1058 of the support body 1052. Each of the front portion 1056 and rear portion 1058 are angled away from each other as they extend from the slot 1054. Accordingly, as the loading tool 1050 is moved downward toward the handle 1092 of the payload 1090, the handle 1092 can be guided toward the slot 1054 that lies between the front portion 1056 and rear portion 1058. Further, the forward trajectory of the guide 1060 also contributes to the funnel shape of the loading tool 1050 and helps direct the payload handle 1092 into the slot 1054. With further insertion of the payload handle 1092 into the slot 1054, the payload handle 1092 is eventually secured in the loading tool 1050 as explained above in greater detail above.

In some embodiments, the hanger includes a ramped surface configured to push the hanger out of the closed position when the loading tool receives a payload. For example, as shown in FIG. 14B, a front surface 1075 of the hook 1072 of the hanger 1070 is ramped so as to be angled slightly downward. As a result, when the payload handle 1092 is inserted into the slot 1054, the handle 1092 engages the ramped front surface 1075 of the hanger 1070 and is able to push the hanger 1070 out of the way. This allows the payload handle 1092 to continue moving into the slot 1054 until the hook 1072 is positioned under the handle 1092. At this point, the hanger 1070 is urged to move back to the closed position (FIG. 13B) under the force of the spring 1078 and support the payload 1090.

In some embodiments, the loading tool is configured to cooperate with the payload holding structure of the payload retrieval apparatus in order to assist in placing the payload onto the payload holding structure. For example, in the illustrated embodiment, the payload holding structure 1040 of the payload retrieval apparatus 1020 is formed by a pair of hooks 1040 shown from the side in FIGS. 12A and 12C. To cooperate with the payload holding structure 1040, as shown in FIG. 11A, and 11C, the loading tool 1050 includes a pair of corresponding cavities 1066 that receive the open end of the hooks 1040. When the loading tool 1050 is holding a payload handle 1092, in order for the ends of the hooks 1040 to move into the corresponding cavities 1066 in the payload retrieval structure 1020, the ends of the hooks 1040 will pass through the appropriate apertures in the payload handle 1092. Accordingly, once the loading tool 1050 is in place on the payload retrieval apparatus, the payload 1090 is ready to be released and securely left on the payload holding structure 1040.

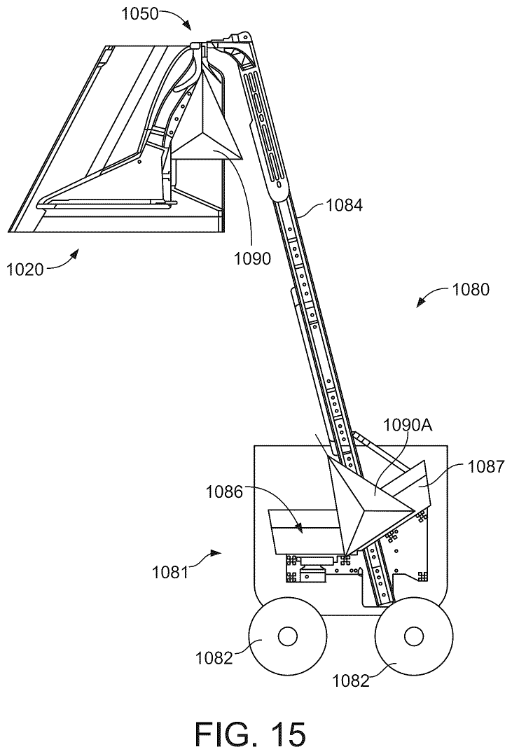

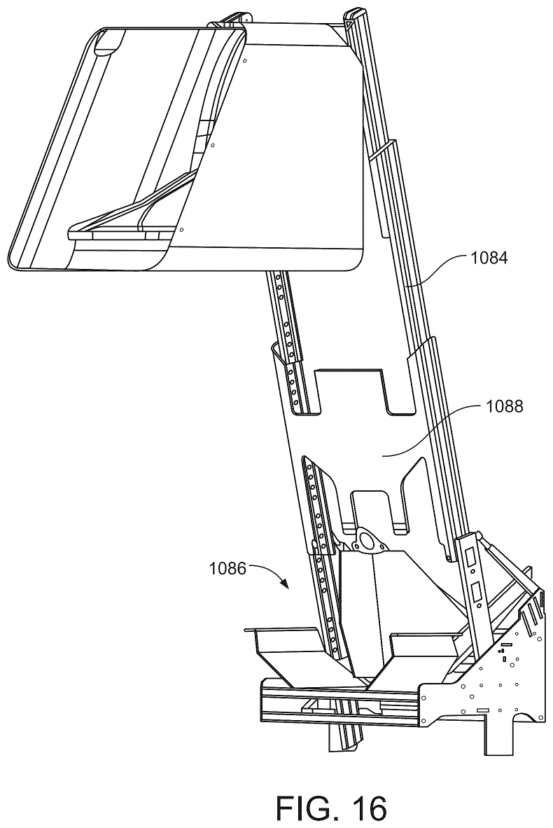

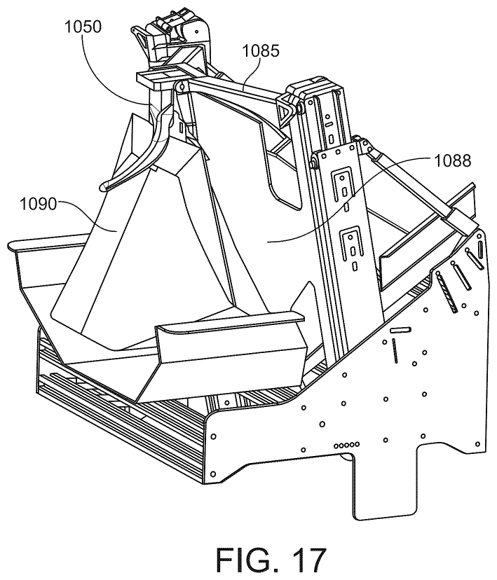

FIGS. 15-17 illustrate an example machine for loading a payload onto a payload retrieval apparatus. As shown in FIG. 15, the loading machine 1080 includes a mobile base 1081 and an adjustable arm 1084 attached to the mobile base 1081. A loading tool 1050 is attached to a distal end of the adjustable arm 1084 such that the adjustable arm 1084 can position the loading tool 1050, and the payload 1090 attached thereto, onto the payload retrieval apparatus 1020. For clarity, the mobile base 1081 in FIG. 15 is shown as transparent to illustrate components of the adjustable arm 1084. Further, the mobile base 1081 is not depicted in FIGS. 16 and 17.

In some embodiments, the mobile base may include a drive for moving the mobile base over a surface. For example, in loading machine 1080, the mobile base 1081 includes a plurality of wheels 1082 and one or more motors for powering the wheels. The motor(s) may be an electric motor, an engine or another configuration. Further, while the illustrated embodiment shows a drive that includes a wheeled mobility system, in other embodiments, the drive may include tracks or legs to provide movement to the mobile base.

To place the loading tool 1050 onto the payload retrieval apparatus 1020, the mobile base 1081 is moved to the vicinity of the payload retrieval apparatus 1020 using the wheels 1082. The adjustable arm 1084 then lifts the loading tool 1050 and payload 1090 up to the exit of the channel of the payload retrieval apparatus 1020. The adjustable arm 1084 then moves down and toward the payload retrieval apparatus 1020 in the manner shown in FIGS. 12A and 12B in order to position the loading tool 1050 in place. Once the payload 1090 has been released, the adjustable arm 1084 removes the loading tool 1050 from the payload retrieval apparatus 1020 and retracts into the mobile base, where it may receive another payload.

In some embodiments, the loading machine includes a storage area for holding a payload. For example, as shown in FIG. 15, mobile base 1081 includes storage area 1086 that is holding another payload 1090A. Such a storage area can be used to hold the payload until it is secured on the loading tool 1050. To secure the payload onto the loading tool, the adjustable arm can retract into the mobile base until the payload handle is secured to the loading tool, as shown in FIG. 17. The attachment of the payload to the loading tool may be facilitated by insertion of the payload handle into the slot of the loading tool, as discussed above with respect to FIGS. 14A and 14B.

In some embodiments, the mobile base may include a chute configured to hold one or more additional payloads for loading by the machine. For example, mobile base 1081 includes a chute 1087 that can hold one additional payload for movement into the storage area after the initial payload is removed by the adjustable arm. Further, as shown in FIG. 16, the machine may include a gate 1088 that controls movement of additional payloads into the storage. When the adjustable arm 1084 is retracted, the gate holds the additional payloads away from the storage area, so as not to interfere with the attachment of the stored payload onto the loading tool. Once the stored payload is retrieved, the gate may be moved to an open position and allow an additional payload to move into the storage area 1086. Moreover, as the gate returns to the closed position, it may push the subsequent payload into the storage position, as shown in FIG. 17.

In the illustrated embodiment, the adjustable arm 1084 is formed by a pair of telescoping portions that are connected by a bridge 1085 (FIG. 17) that holds the loading tool 1050 at the end of the arm. In other embodiments, the adjustable arm may be formed by other articulating components. Further, while the loading tool is shown at the distal end of the adjustable arm, in other embodiments, it may be positioned on another portion of the arm.

### VIII. Conclusion

The particular arrangements shown in the Figures should not be viewed as limiting. It should be understood that other implementations may include more or less of each element shown in a given Figure. Further, some of the illustrated elements may be combined or omitted. Yet further, an exemplary implementation may include elements that are not illustrated in the Figures.

Additionally, while various aspects and implementations have been disclosed herein, other aspects and implementations will be apparent to those skilled in the art. The various aspects and implementations disclosed herein are for purposes of illustration and are not intended to be limiting, with the true scope and spirit being indicated by the following claims. Other implementations may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

1. A tool for loading a payload on a payload retrieval apparatus, the tool comprising:
a support body;
a guide extending outward from the support body, the guide having an elongated configuration and a cross-sectional area that is narrower than the support body, wherein the guide is configured to be inserted into a channel of the payload retrieval apparatus and to position the support body at an end of the channel adjacent to a payload holding structure; and
a hanger configured to hold a payload, the hanger being movable with respect to the support body between a closed position and a release position.

2. The tool according to claim 1, wherein the support body includes a front portion and a rear portion, and wherein a slot is formed between the front portion and rear portion for receiving a handle of a payload.

3. The tool according to claim 2, wherein the hanger includes a hook.

4. The tool according to claim 3, wherein the hook extends across the slot when the hanger is in the closed position.

5. The tool according to claim 4, wherein the hook is configured to move into a receptacle in the rear portion of the support body when the hanger moves from the closed position to the release position such that a front surface of the rear portion of the support body slides the handle of the payload off the hook.

6. The tool according to claim 2, wherein the front portion and the rear portion form a funnel for guiding a handle of a payload into the slot.

7. The tool according to claim 2, wherein the payload holding structure includes at least one hook, and wherein a front surface of the rear portion of the support body includes a receptacle for the hook.

8. The tool according to claim 7, wherein a switch is configured to move the hanger from the closed position to the release position.

9. The tool according to claim 8, wherein the switch is formed by a contact surface on the hanger that is configured to engage the payload retrieval apparatus when the guide is inserted into the channel.

10. The tool according to claim 1, wherein the hanger is biased toward the closed position.

11. The tool according to claim 10, wherein the hanger includes a ramped surface configured to push the hanger out of the closed position when the tool receives a payload.

12. A machine for loading a payload onto a payload retrieval apparatus, the machine comprising:
a mobile base including a drive for moving the base over a surface;
an adjustable arm attached to the mobile base;
a tool according to claim 1 attached to the adjustable arm.

13. The machine according to claim 12, wherein the mobile base includes a storage area for holding a payload.

14. The machine according to claim 13, wherein the adjustable arm is movable to a delivery position where the payload is loadable onto the payload retrieval apparatus and to a receiving position where the tool receives a payload from the storage area.

15. The machine according to claim 13, wherein the mobile base includes a chute configured to hold additional payloads for refilling the storage area.

16. The machine according to claim 15, further comprising a gate configured to release the additional payloads into the storage area.

17. The machine according to claim 16, wherein the gate is coupled to the adjustable arm and activation of the gate is facilitated by movement of the arm.

18. A method of loading a payload onto a payload retrieval apparatus, the method comprising:
securing a payload to a loading tool comprising:
a support body,
a guide extending outward from the support body, the guide having an elongated configuration and a cross-sectional area that is narrower than the support body, and
a hanger that holds the payload;
inserting the guide of the loading tool into a channel of the payload retrieval apparatus so as to position the support body at an end of the channel adjacent to a payload holding structure of the payload retrieval apparatus;
moving the hanger of the loading tool with respect to the support body from a closed position to a release position to release the payload such that the payload is held by the payload holding structure of the payload retrieval apparatus.

19. The method according to claim 18, wherein the loading tool is attached to an adjustable arm of a machine, and wherein inserting the guide of the loading tool into the channel of the payload retrieval apparatus includes moving the adjustable arm to locate the loading tool such that the guide extends into the channel.

20. The method according to claim 19, wherein securing the payload to the loading tool includes moving the adjustable arm to move the loading tool to a storage area of the machine.
